(19) United States
(12) Patent Application Publication
(10) Pub. No.: US 2026/0281256 A1
(43) Pub. Date: Sep. 17, 2026

(54) IMAGE FORMING APPARATUS, SETTING ASSISTANCE METHOD AND COMPUTER-READABLE RECORDING MEDIUM ENCODED WITH SETTING ASSISTANCE PROGRAM

(71) Applicant: Konica Minolta, Inc., Tokyo (JP)

(72) Inventor: Toshiyuki SASAKI, Toyokawa-shi (JP)

(73) Assignee: Konica Minolta, Inc., Tokyo (JP)

(21) Appl. No.: 19/561,681

(22) Filed: Mar. 10, 2026

(30) Foreign Application Priority Data
Mar. 14, 2025 (JP) 2025-041481

(51) Int. Cl. H04N 1/00

(52) U.S. Cl. CPC H04N 1/00087; H04N 1/00076; H04N 1/00092; H04N 1/00411; H04N 1/00477; H04N 1/00724; H04N 2201/0094

(57) ABSTRACT

An image forming apparatus includes a hardware processor, wherein the hardware processor sets a type of a recording medium, detects the type of a recording medium on which an image is to be formed, determines, in a first mode, an image formation condition based on the set type, and determines, in a second mode, the image forming condition based on the detected type, sets a work mode to either the first mode or the second mode, and in a case of, with the first mode being set, a specific state where the set type is different from the detected type, prompts switching of the work mode.

### CROSS-REFERENCE TO RELATED APPLICATIONS

The entire disclosure of Japanese patent Application No. 2025-041481 filed on Mar. 14, 2025, is incorporated herein by reference in its entirety.

### BACKGROUND OF THE INVENTION

### Technical Field

The present invention relates to an image forming apparatus, a setting assistance method and a computer-readable recording medium encoded with a setting assistance program. In particular, the present invention relates to an image forming apparatus that forms an image on a recording medium according to a condition corresponding to the type of the recording medium, a setting assistance method executed by the image forming apparatus, and a computer-readable recording medium encoded with a setting assistance program that causes a computer to execute the setting assistance method.

### Description of Related Art

In an image forming apparatus such as an Multi Function Peripheral (MFP), sheets are taken out one by one from a sheet feed tray storing a plurality of recording media, and an image is formed on a recording medium being conveyed. In this MFP, in order to improve the quality of an image formed on a recording medium, different conditions are used for formation of images according to the types of recording media. However, in a case in which the type of a recording medium set by a user is incorrect, an image is formed on a recording medium according to the image forming condition defined by the type of the recording medium. In this case, a malfunction such as a sheet jam may occur.

Therefore, a technique for automatically detecting the sheet type of a recording medium is known (Patent Document 1, for example) On the other hand, it may be desired to form an image according to an image forming condition defined by a sheet type set by the user. Therefore, although there is no problem in a case in which a sheet type set by the user and an automatically detected sheet type are the same, a malfunction may occur in a case in which they are different. For example, after the user incorrectly sets a sheet type, another user may use the image forming apparatus. In this case, the other user does not recognize that an image is not formed according to an image forming condition corresponding to a sheet type. Therefore, the user is not aware that he or she is to change the setting such that an image is formed according to the image forming condition corresponding to the sheet type. Further, even when a failure such as a sheet jam occurs in a case in which an image is formed in such a state, it is not possible to recognize the setting of a sheet type as the cause.

### SUMMARY OF THE INVENTION

According to one aspect of the present invention, an image forming apparatus includes a hardware processor, wherein the hardware processor sets a type of a recording medium, detects the type of a recording medium on which an image is to be formed, determines, in a first mode, an image formation condition based on the set type, and determines, in a second mode, the image forming condition based on the detected type, sets a work mode to either the first mode or the second mode, and in a case of, with the first mode being set, a specific state where the set type is different from the detected type, prompts switching of the work mode.

According to another aspect of the present invention, a setting assistance method includes a type setting step of setting a type of a recording medium, a detecting step of detecting the type of a recording medium on which an image is to be formed, an image forming condition determining step of determining an image forming condition based on the type set in the type setting step in a first mode, and determining an image forming condition based on the type detected in the detecting step in a second mode, a mode setting step of setting a work mode to either the first mode or the second mode, and a notifying step of prompting switching of the work mode in a case of, with the first mode being set, a specific state where the type set in the type setting step is different from the type detected in the detecting step.

According to another aspect of the present invention, a computer-readable recording medium is encoded with a setting assistance program that causes a computer controlling an image forming apparatus to execute a type setting step of setting a type of a recording medium, a detecting step of detecting the type of a recording medium on which an image is to be formed, an image forming condition determining step of determining an image forming condition based on the type set in the type setting step in a first mode, and determining an image forming condition based on the type detected in the detecting step in a second mode, a mode setting step of setting a work mode to either the first mode or the second mode, and a notifying step of prompting switching of the work mode in a case of, with the first mode being set, a specific state where the type set in the type setting step is different from the type detected in the detecting step.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a perspective view illustrating the appearance of an MFP in the present embodiment;

FIG. 2 is a block diagram illustrating the outline of the hardware configuration of the MFP;

FIG. 3 is a schematic side view illustrating the inner configuration of part of an image forming section and a sheet feed section;

FIG. 4 is a diagram schematically illustrating one example of an optical sensor;

FIG. 5 is a diagram illustrating one example of the functions of a CPU of the MFP in the present embodiment;

FIG. 6 is a diagram illustrating one example of a sheet type table;

FIG. 7 is a diagram illustrating one example of a first notification screen;

FIG. 8 is a flowchart illustrating one example of a flow of a setting assistance process;

FIG. 9 is a diagram illustrating one example of the functions of a CPU of an MFP in a first modification example;

FIG. 10 is a diagram illustrating one example of a second notification screen;

FIG. 11 is a flowchart illustrating one example of a flow of a setting assistance process in the first modification example;

FIG. 12 is a flowchart illustrating one example of a flow of a resuming process;

FIG. 13 is a diagram illustrating a modification example of a second notification screen;

FIG. 14 is a diagram illustrating one example of the functions of a CPU of an MFP in a second modification example;

FIG. 15 is a diagram illustrating one example of a third notification screen;

FIG. 16 is a flowchart illustrating one example of a flow of a setting assistance process in the second modification example; and

FIG. 17 is a diagram illustrating one example of a fourth notification screen.

### DETAILED DESCRIPTION

Hereinafter, one or more embodiments of the present invention will be described with reference to the drawings. However, the scope of the invention is not limited to the disclosed embodiments.

An image forming apparatus in embodiments of the present invention will be described below with reference to the drawings. In the following description, the same components are denoted by the same reference numerals. Their names and functions are the same. Therefore, the detailed description thereof will not be repeated. Further, in the following description, an MFP will be described as one example of the image forming apparatus. Further, in the below-mentioned MFP, a recording medium on which an image is to be formed is a sheet P. As the sheet P, a paper such as a plain paper, a high-quality paper, a recycled paper or a photo paper, or an Over Head Projector (OHP) film, or a double-layer paper in which two sheets P are superimposed such as an envelope is used.

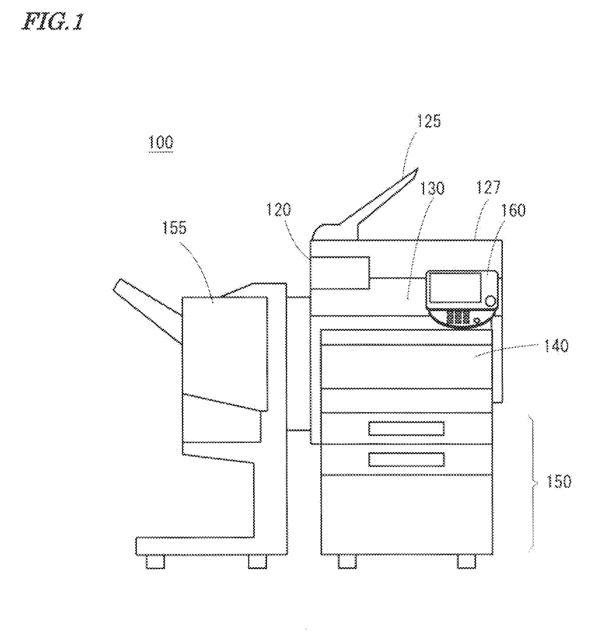

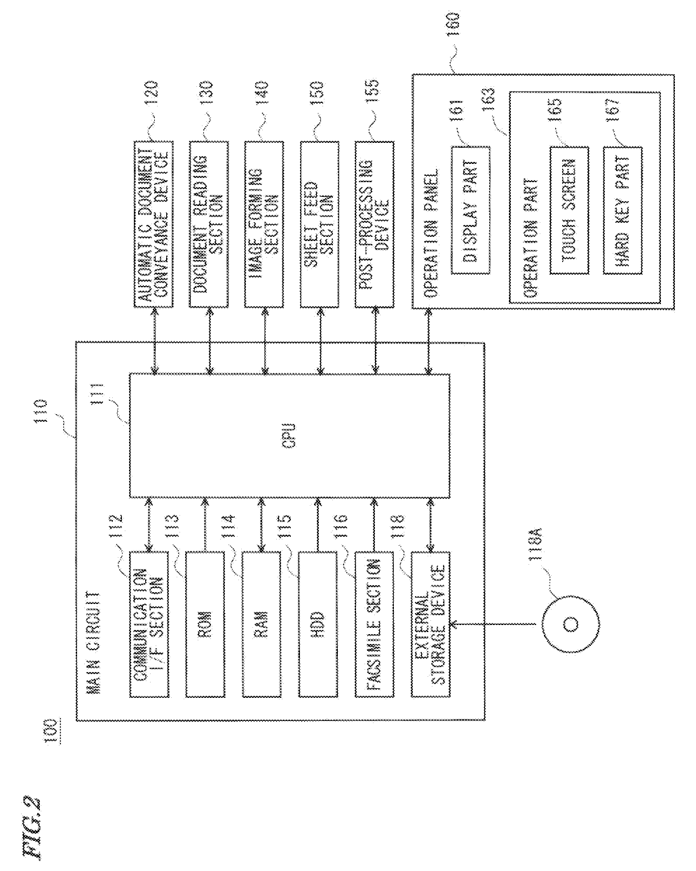

FIG. 1 is a perspective view illustrating the appearance of the MFP in the present embodiment. FIG. 2 is a block diagram illustrating the outline of the hardware configuration of the MFP. With reference to FIGS. 1 and 2, the MFP 100 is one example of the image forming apparatus. The MFP 100 includes a main circuit 110, an automatic document conveyance device 120, a document reading section 130, an image forming section 140, a sheet feed section 150, a post-processing device 155 and an operation panel 160. The document reading section 130 reads a document. The automatic document conveyance device 120 conveys a document to the document reading section 130. The image forming section 140 forms an image on the sheet P based on image data. The sheet feed section 150 supplies the sheet P to the image forming section 140.

The automatic document conveyance device 120 automatically conveys a plurality of documents set on a document tray 125 to a document reading position of the document reading section 130 one by one, and discharges a document having an image formed thereon and read by the document reading section 130 onto a document ejection tray 127. The automatic document conveyance device 120 includes a document detection sensor for detecting a document placed on the document tray 125.

The document reading section 130 has a rectangular reading surface for reading a document. The reading surface is formed of a platen glass, for example. The automatic document conveyance device 120 is connected to the main body of the MFP 100 to be rotatable about an axis parallel to one side of the reading surface and is openable and closable. The document reading section 130 is arranged below the automatic document conveyance device 120, and the reading surface of the document reading section 130 is exposed with the automatic document conveyance device 120 rotated and open. Thus, a user can place a document on the reading surface of the document reading section 130. The automatic document conveyance device 120 can change between an open state in which the reading surface of the document reading section 130 is exposed and a close state in which the reading surface is covered. The automatic document conveyance device 120 includes a state detection sensor that detects the open state of the automatic document conveyance device 120.

The document reading section 130 includes a light source that emits light and an optoelectronic transducer that receives light, and scans an image formed on a document placed on the reading surface. In a case in which a document is placed on a reading area, the light emitted from the light source is reflected from the document, and the reflected light forms an image on the optoelectronic transducer. When receiving the light reflected from the document, the optoelectronic transducer produces image data by converting the received light into an electrical signal. The document reading section 130 outputs the image data to a CPU 111 included in the main circuit 110.

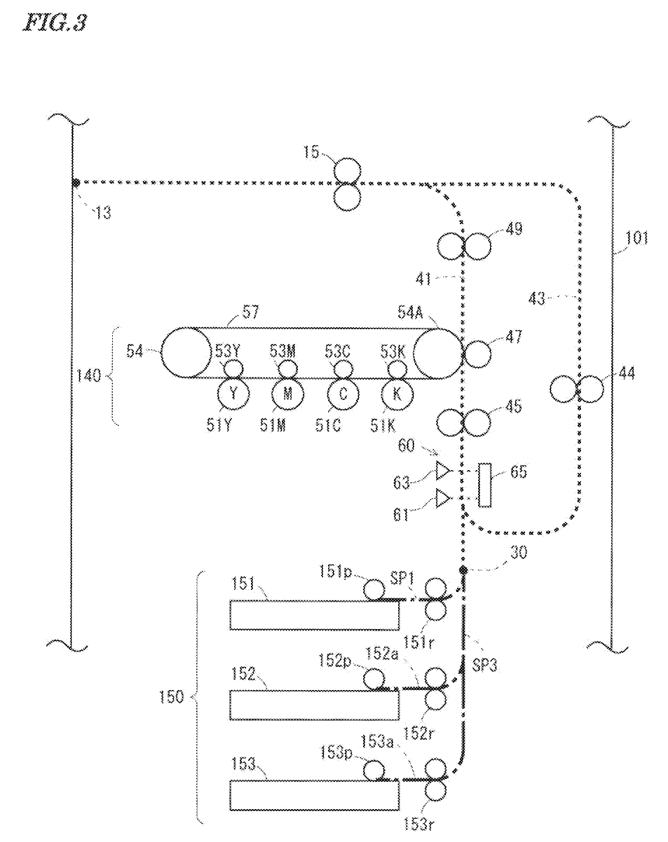

The sheet feed section 150 takes out a recording medium stored in any of three sheet feed trays 151, 152, 153 (see FIG. 3), described below, conveys the recording medium to the image forming section 140 as an object to be conveyed.

The image forming section 140 is controlled by the CPU 111, and forms an image on the sheet P conveyed by the sheet feed section 150 using a known electrophotographic method. In the present embodiment, the image forming section 140 forms an image of image data received from the CPU 111 on the sheet P conveyed by the sheet feed section 150. The sheet P on which the image is formed is discharged to the post-processing device 155. The image data that is output by the CPU 111 to the image forming section 140 includes image data such as externally received printing data in addition to the image data received from the document reading section 130.

The post-processing device 155 receives the sheet P on which an image has been formed by the image forming section 140, and executes post-processing on the sheet P. The post-processing device 155 includes a plurality of sheet ejection trays and ejects the sheet P received from the image forming section 140 to any one of the plurality of sheet ejection trays. While not being limited, the post-processing device 155 executes a process of sorting a plurality of sheets P by conveying the plurality of sheets P to any one of the plurality of sheet ejection trays, a process of punching the sheets P and a process of stapling the sheets P.

The main circuit 110 includes a Central Processing Unit (CPU) 111 for controlling the MFP 100 as a whole, a communication I/F section 112, a Read Only Memory (ROM) 113, a Random Access Memory (RAM) 114, a Hard Disc Drive (HDD) 115 that is used as a mass storage device, a facsimile section 116 and an external storage device 118. The CPU 111 is connected to the automatic document conveyance device 120, the document reading section 130, the image forming section 140, the sheet feed section 150, the post-processing device 155 and the operation panel 160, and controls the MFP 100 as a whole.

The ROM 113 stores a program to be executed by the CPU 111 or data that is required for execution of the program. The RAM 114 is used as a work area when the CPU 111 executes a program. Further, the RAM 114 temporarily stores image data successively sent from the document reading section 130.

The operation panel 160 is provided in an upper portion of the MFP 100. The operation panel 160 includes a display part 161 and an operation part 163. The display part 161 is a Liquid Crystal Display Device (LCD), for example, and displays an instruction menu for a user, information about acquired image data, etc. As long as displaying images, an organic Electroluminescence (EL) display, for example, can be used instead of the LCD.

The operation part 163 includes a touch screen 165 and a hard key part 167. The touch screen 165 is a capacitance type. The touch screen 165 is not limited to the capacitance type, and another type such as a resistive film type, a surface acoustic wave type, an infrared type and an electromagnetic induction type can be used.

The touch screen 165 is provided with its detection surface being superimposed on an upper surface or a lower surface of the display part 161. Here, the size of the detection surface of the touch screen 165 and the size of the display surface of the display part 161 are the same. Therefore, the coordinate system of the display surface and the coordinate system of the detection surface are the same. The touch screen 165 detects, using the detection surface, a position designated by the user on the display surface of the display part 161, and outputs a set of coordinates of the detected position to the CPU 111. Because the coordinate system of the display surface and the coordinate system of the detection surface are the same, the set of coordinates output by the touch screen 165 can be replaced with the set of coordinates of the display surface.

The hard key part 167 includes a plurality of hard keys. The hard keys are contact switches, for example. The touch screen 165 detects a position designated by the user on the display surface of the display part 161. In a case in which operating the MFP 100, the user is likely to be in an upright posture. Therefore, the display surface of the display part 161, the operation surface of the touch screen 165 and the hard key part 167 are arranged to face upwardly. This is for the purpose of enabling the user to easily view the display surface of the display part 161 and easily provide an instruction on the operation part 163 with his or her finger.

The communication I/F section 112 is an interface for connecting the MFP 100 to a network. The communication I/F section 112 communicates with another computer or a data processing apparatus connected to the network using a communication protocol such as a Transmission Control Protocol (TCP) or a File Transfer Protocol (FTP). The network to which the communication I/F section 112 is connected is a Local Area Network (LAN), either wired or wireless. Further, the network is not limited to a LAN and may be a Wide Area Network (WAN), a Public Switched Telephone Network (PSTN), the Internet or the like.

The facsimile section 116 is connected to the Public Switched Telephone Network (PSTN), transmits facsimile data to the PSTN or receives facsimile data from the PSTN. The facsimile section 116 stores the received facsimile data in the HDD 115, converts the facsimile data into printing data that is printable in the image forming section 140 and outputs the printing data to the image forming section 140. Thus, the image forming section 140 forms an image represented by the facsimile data received from the facsimile section 116 on the sheet P. Further, the facsimile section 116 converts the data stored in the HDD 115 into facsimile data and transmits the converted facsimile data to a facsimile machine connected to the PSTN.

The external storage device 118 is controlled by the CPU 111 and mounted with a Compact Disk Read Only Memory (CD-ROM) 118A or a semiconductor memory. In the present embodiment, the CPU 111 executes a program stored in the ROM 113, by way of example. The CPU 111 may control the external storage device 118 to read a program to be executed by the CPU 111 from the CD-ROM 118A and store the read program in the RAM 114 for execution.

Note that a combination of two or more of processors such as a Micro Processing Unit (MPU), a Graphics Processing Unit (GPU) and a Digital Signal Processor (DSP) may be used instead of the CPU 111. A processor may be a Field-Programmable Gate Array (FPGA) or an Application Specific Integrated Circuit (ASIC).

It is noted that a recording medium for storing a program to be executed by the CPU 111 is not limited to the CD-ROM 118A. It may be a flexible disc, a cassette tape, an optical disc, an IC card, an optical card, and a semiconductor memory such as a mask ROM or an Erasable Programmable ROM (EPROM). The optical disc includes Magnetic Optical Disc (MO)/MiniDisc(MD)/Digital Versatile Disc(DVD). Further, the CPU 111 may load a program stored in the HDD 115 into the RAM 114 for execution in the CPU 111. The program stored in the HDD 115 includes a program downloaded by the CPU 111 from a computer connected to the Internet, or a program written in the HDD 115 by a computer connected to the Internet. The program referred to here includes not only a program directly executable by the CPU 111 but also a source program, a compressed program, an encrypted program or the like.

FIG. 3 is a schematic side view illustrating the inner configuration of part of the image forming section and the sheet feed section. With reference to FIG. 3, a main conveyance route 41 indicated by the thick dotted line is formed to basically extend in an upward-and-downward direction in the MFP 100. The main conveyance route 41 is a route for guiding the sheet P that is conveyed from the sheet feed section 150 to the post-processing device 155 through the image forming section 140. In the main conveyance route 41 of the present example, a lower end portion 30 opposite to an upper end portion 13 located above the image forming section 140 forms an inlet port for receiving the sheet P from the sheet feed section 150. Further, the upper end portion 13 of the main conveyance route 41 forms a discharge port for discharging the sheet P on which an image is formed to the post-processing device 155. A sheet ejection roller 15 is provided at the upper end portion 13 of the main conveyance route 41. The lower end portion 30 of the main conveyance route 41 is connected to a plurality of sub-conveyance routes SP1, SP2, SP3 of the sheet feed section 150, described below.

The sheet feed section 150 includes the three sheet feed trays 151, 152, 153. The three sheet feed trays 151, 152, 153 are arranged in this order from above toward below. As indicated by the thick one dot chain line in FIG. 3, in the sheet feed section 150, the sub-conveyance route SP1 is formed to extend from the sheet feed tray 151, which is the top tray among the three sheet feed trays 151, 152, 153, to the lower end portion 30 of the main conveyance route 41. Further, two sub-conveyance routes 152a,153a are formed to respectively extend from the sheet feed trays 152, 153, which are the middle and bottom trays among the three sheet feed trays 151, 152, 153, to the lower end portion 30 of the main conveyance route 41. The portion having a predetermined length from the lower end portion 30 of the main conveyance route 41 to the point where the main conveyance route 41 branches into the two sub-conveyance routes 152a, 153a is the sub-conveyance route SP3, which is shared by the two sub-conveyance routes 152a, 153a.

A pickup roller 151p and a sheet feed roller 151r are provided to correspond to the sheet feed tray 151. The sheet feed roller 151r is provided in the sub-conveyance route SP1. A pickup roller 152p and a sheet feed roller 152r are provided to correspond to the sheet feed tray 152. The sheet feed roller 152r is provided in the sub-conveyance route 152a. A pickup roller 153p and a sheet feed roller 153r are provided to correspond to the sheet feed tray 153. The sheet feed roller 153r is provided in the sub-conveyance route 153a. Taking out a recording medium from each of the sheet feed trays 151, 152, 153 and conveying the recording medium is a common work performed with the sheet feed trays 151, 152, 153. Here, a recording medium is taken out from the sheet feed tray 151, by way of example.

In the sheet feed tray 151, one or a plurality of sheets P are stored in a stack. The sheet feed tray 151 has a lift-up mechanism that lifts the one or plurality of sheets P stored therein. The pickup roller 151p is biased downwardly by an elastic member such as a spring while abutting against the sheet P at the top out of one or more sheets P stored in the sheet feed tray 151 from above. The pickup roller 151p presses the sheet P from above. The pickup roller 151p rotates, so that the sheet P at the top is sent out to the sub-conveyance route SP1 by the friction force between the pickup roller 151p and the sheet P. The sheet P sent out to the sub-conveyance route SP1 is supplied to the main conveyance route 41 by the sheet feed roller 151r. A process to be executed on the sheet P that has been sent out to the sub-conveyance route SP1 by the pickup roller 151p and conveyed by the sheet feed roller 151r will be described below.

Due to the rotation of the pickup roller 151p, the sheet P at the top out of the one or more sheets P stored in the sheet feed tray 151 is sent out to the sub-conveyance route SP1 by the friction between the pickup roller 151p and the sheet P. In this case, although receiving a frictional force from the sheet P at the top, the sheet P that is the second from the top and superimposed on the sheet P at the top receives a frictional force from the sheet P that is the third from the top and superimposed, from below, on the sheet P that is the second from the top. Therefore, a force that biases the pickup roller 151p is adjusted such that only the sheet P that is at the top is sent out to the sub-conveyance route SP1.

In the MFP 100, when an image is formed, a tray storing a sheet P on which an image is to be formed is selected from among the three sheet feed trays 151, 152, 153 as a subject tray. The pickup roller and the sheet feed roller corresponding to the tray selected as the subject tray from among the three sheet feed trays 151, 152, 153 work. Thus, an object to be conveyed is supplied from the tray selected as the subject tray to the main conveyance route 41 through one of the sub-conveyance routes SP1, SP3.

The image forming section 140 includes respective image forming units 51Y, 51M, 51C, 51K for respective yellow, magenta, cyan and black. An image is formed on the sheet P by driving of at least one of the image forming units 51Y, 51M, 51C, 51K. When all of the image forming units 51Y, 51M, 51C, 51K are driven, a full-color image is formed. Printing data pieces for yellow, magenta, cyan and black are respectively input to the image forming units 51Y, 51M, 51C, 51K. The only difference among the image forming units 51Y, 51M, 51C, 51K is the colors of toners used by the image forming units 51Y, 51M, 51C, 51K. Therefore, the image forming unit 51Y for forming an image in yellow will be described here.

The image forming unit 51Y includes an exposure head to which printing data for yellow is input, a photosensitive drum (an image bearing member), an electric charger, a developing device and a transfer roller 53Y. The exposure head emits laser light in accordance with the received printing data (electrical signal). A polygon mirror included in the exposure head scans the emitted laser light one-dimensionally to expose the photosensitive drum. The direction in which the laser light one-dimensionally scans the photosensitive drum is a main scanning direction. After being electrically charged by the electric charger, the photosensitive drum is irradiated with the laser light emitted by the exposure head. Thus, an electrostatic latent image is formed on the photosensitive drum. Subsequently, toner is applied onto the electrostatic latent image by the developing device, so that a toner image is formed. The toner image formed on the photosensitive drum is transferred onto an intermediate transfer belt 57 by the transfer roller 53Y.

On the other hand, the intermediate transfer belt 57 is suspended by a driving roller 54 and a roller 54A not to loosen. When the driving roller 54 is rotated counterclockwise in the diagram, the intermediate transfer belt 57 is rotated counterclockwise in the diagram at a predetermined speed. The roller 54A is rotated counterclockwise due to the rotation of the intermediate transfer belt 57.

Thus, the image forming units 51Y, 51M, 51C, 51K sequentially transfer toner images onto the intermediate transfer belt 57. Timing for transferring toner images onto the intermediate transfer belt 57 by the respective image forming units 51Y, 51M, 51C, 51K is adjusted by detection of a reference mark provided on the intermediate transfer belt 57. Thus, toner images in yellow, magenta, cyan and black are superimposed on the intermediate transfer belt 57.

In the above-mentioned main conveyance route 41, a timing roller 45, a transfer roller 47, a fixing roller 49 and a sheet ejection roller 15 are arranged in this order at intervals from the lower end portion 30 to the upper end portion 13. An object that is to be conveyed and has been supplied from the sheet feed section 150 to the main conveyance route 41 is sent to the timing roller 45.

The timing roller 45 adjusts the conveyance state of the sheet P in the main conveyance route 41 such that the sheet P arrives at the transfer roller 47 at a point in time at which a toner image formed on the intermediate transfer belt 57 arrives at the transfer roller 47. The sheet P conveyed by the timing roller 45 is pressed against the intermediate transfer belt 57 by the transfer roller 47. Because the transfer roller 47 is electrically charged, yellow, magenta, cyan and black toner images that are formed on the intermediate transfer belt 57 in a superimposed manner are transferred to the sheet P. A voltage to be applied to the transfer roller 47 is controlled by the CPU 111 such that the value of a charging amount of the transfer roller 47 is suitable for the basis weight of the sheet P.

The sheet P to which the toner image has been transferred is conveyed to the fixing roller 49 and heated by the fixing roller 49. Thus, toner is fused and fixed to the sheet P. Thereafter, the sheet P on which the image has been formed is discharged to the post-processing device 155 from the upper end portion 13 of the main conveyance route 41 by the sheet ejection roller 15. The temperature of the fixing roller 49 is controlled by the CPU 111 to be suitable for the basis weight of the sheet P.

An inverting route 43 that branches from the main conveyance route 41 is provided. One end of the inverting route 43 is connected to the sheet ejection roller 15, and the other end of the inverting route 43 is connected between the lower end portion 30 of the main conveyance route 41 and an optical sensor 60. In the inverting route 43, an inverting roller 44 is arranged.

In a period during which the sheet P stored in any one of the sheet feed tray 151, the sheet feed tray 152 and the sheet feed tray 153 is conveyed along the main conveyance route 41, an image is transferred onto the surface of the sheet P by the transfer roller 47, and the sheet P is conveyed to the sheet ejection roller 15. When an image is formed on the back surface of the sheet P, the sheet ejection roller 15 reverses the rotation direction while gripping the sheet P without conveying the sheet P to the post-processing device 155. Thus, the conveyance direction of the sheet P is reversed, and the sheet P enters the inverting route 43. The sheet P that has entered the inverting route 43 is conveyed by the inverting roller 44 and enters the main conveyance route 41. Thereafter, the sheet P is conveyed along the main conveyance route 41, and an image is transferred onto the back surface of the sheet P by the transfer roller 47. Then, the sheet P having the back surface to which the image has been transferred passes through the fixing roller 49 and is discharged to the post-processing device 155 by the sheet ejection roller 15.

In the MFP 100 in the present embodiment, the optical sensor 60 which has a detection area in the main conveyance route 41 is provided.

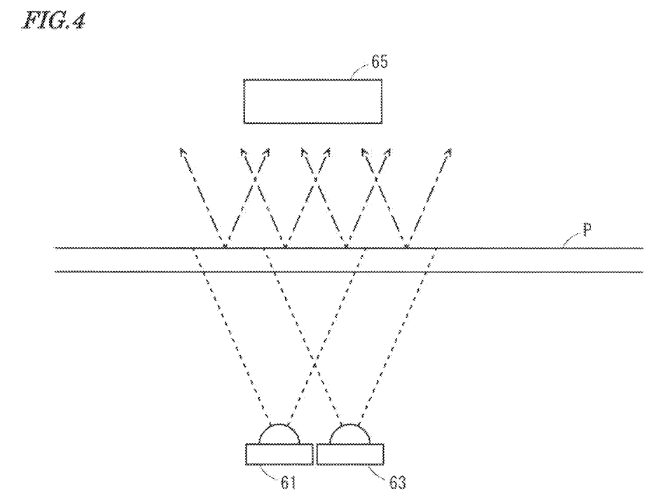

FIG. 4 is a diagram schematically illustrating one example of the optical sensor. With reference to FIG. 4, the optical sensor 60 includes a blue Light Emitting Diode (LED) 61, a red LED 63 and a photodiode 65. The blue LED 61 and the red LED 63 are respectively light sources for transmission. The blue LED 61 and the red LED 63 are opposite to the photodiode 65 with the main conveyance route 41 interposed therebetween. The blue LED 61 and the red LED 63 irradiate the sheet P that is conveyed through the detection area with light. The photodiode 65 receives the light that has transmitted through the sheet P and has each color. The optical sensor 60 outputs a value indicating the transmittance of light. The transmittance indicates the ratio of an amount of light received by the photodiode 65 to an amount of light output by each of the blue LED 61 and the red LED 63. The transmittance of light of each of the two color types differs depending on the basis weight of the sheet P, and there is a predetermined relationship between the transmittance of light of each of the two types and the basis weight of the sheet P. In general, the larger the basis weight of the sheet P, the smaller the transmittance of light. Therefore, the relationship between the basis weight of the sheet P and the transmittance of light of each of the two types is obtained by an experiment or the like, so that the CPU 111 determines the basis weight of the sheet P based on the transmittance of light of each of the two types.

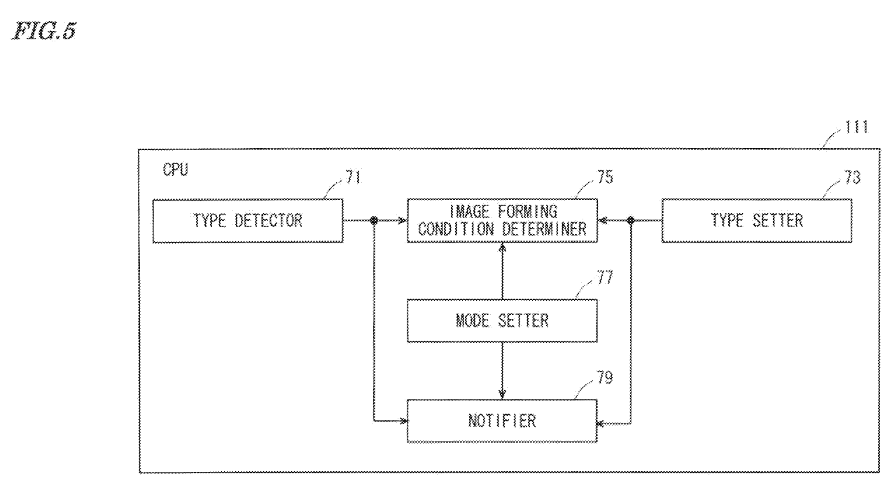

FIG. 5 is a diagram illustrating one example of the functions of the CPU of the MFP in the present embodiment. The functions illustrated in FIG. 5 are implemented by the CPU 111 included in the MFP 100 when the CPU 111 executes a setting assistance program stored in the ROM 113, the HDD 115 or the CD-ROM 118A. With reference to FIG. 5, the CPU 111 includes a type detector 71, a type setter 73, an image forming condition determiner 75, a mode setter 77 and a notifier 79.

The type detector 71 controls the optical sensor 60 to detect the type of a sheet P based on an output of the optical sensor 60. The optical sensor 60 outputs the transmittance of light of each of the two types. The type detector 71 determines the basis weight based on the transmittance of light of each of the two types using a basis weight table stored in advance. The basis weight table includes a basis weight record that associates the transmittance of light of two types with a basis weight. For example, a basis weight record associates a basis weight with a range of transmittance. Furthermore, the type detector 71 determines a sheet type based on a basis weight using a sheet type table. A sheet type detected by the type detector 71 is a detected sheet type. The type detector 71 outputs a detected sheet type to the image forming condition determiner 75 and the notifier 79.

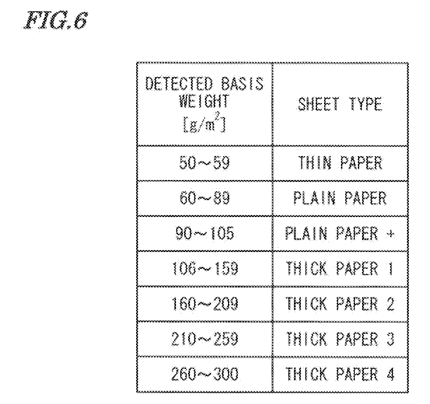

FIG. 6 is a diagram illustrating one example of the sheet type table. With reference to FIG. 6, the sheet type table includes sheet type records that associate basis weights with sheet types. A sheet type record includes an item for a detected basis weight and an item for a sheet type. In the item for a detected basis weight, the range of basis weight is set. In the item for a sheet type, a sheet type is set. For example, a sheet type “THIN PAPER” is associated with the range of basis weight equal to or larger than 50 g/m² and equal to or smaller than 59 g/m².

With reference back to FIG. 5, the type setter 73 sets, for each of the sheet feed trays 151, 152, 153, a sheet type indicating the type of sheet P to be stored therein. The type setter 73 sets a sheet type to be input to the operation part 163 by the user. The type setter 73 stores the sheet type in a predetermined storage device. In the present embodiment, the type setter 73 stores a sheet type in a predetermined area of the HDD 115. The type setter 73 may store a default sheet type in the HDD 115 in the factory default state. In this case, the type setter 73 stores the default sheet type in the predetermined storage area of the HDD 115 in a factory. The user can change the default sheet type to any sheet type by operating the operation part 163. A basis weight may be described on the package of the sheet P. The user can set the sheet type corresponding to a basis weight described on the package with reference to the sheet type table when sheets P are stored in the sheet feed trays 151, 152, 153. A sheet type that is set by the type setter 73 is a set sheet type. The type setter 73 outputs a set sheet type stored in the HDD 115 to the image forming condition determiner 75 and the notifier 79.

The mode setter 77 sets a work mode for determining a condition that varies depending on a sheet type among image forming conditions to either a first mode or a second mode. The image forming section 140 forms an image on a sheet P according to an image forming condition. In regard to a condition that varies depending on a sheet type among image forming conditions, different values are set for different sheet types. Here, conditions that vary depending on sheet types among image forming conditions include a conveyance speed, a fixing temperature and a fixing pressure. A conveyance speed is a speed at which the sheet feed section 150 conveys a sheet P. A conveyance speed is equal to a speed of the intermediate transfer belt 57, and is also a speed at which the image forming section 140 forms an image on a sheet P. A fixing temperature is a temperature of the fixing roller 49. A fixing pressure is a pressure with which the fixing roller 49 pressurizes a sheet P.

In the first mode, an image forming condition is determined based on a type that is set by the type setter 73. In the second mode, an image forming condition is determined based on a type that is detected by the type detector 71. The mode setter 77 outputs a work mode to the image forming condition determiner 75 and the notifier 79.

The image forming condition determiner 75 receives a detected sheet type from the type detector 71, receives a set sheet type from the type setter 73, and receives a work mode from the mode setter 77. The image forming condition determiner 75 determines an image forming condition based on either a detected sheet type or a set sheet type.

The image forming condition determiner 75 determines which one of a set sheet type and a detected sheet type is to be used according to a work mode. The image forming condition determiner 75 selects a set sheet type in a case in which the work mode is set to the first mode, and selects a detected sheet type in a case in which the work mode is set to the second mode. In a case in which the work mode is set to the first mode, the image forming condition determiner 75 determines an image forming condition based on a set sheet type. In a case in which the work mode is set to the second mode, the image forming condition determiner 75 determines an image forming condition based on a detected sheet type.

The notifier 79 receives a detected sheet type from the type detector 71, receives a set sheet type from the type setter 73, and receives a work mode from the mode setter 77. The notifier 79 provides a notification in the case of a specific state with the work mode set to the first mode. In the specific state, a set sheet type is different from a detected sheet type. The type detector 71 detects a detected sheet type each time a sheet P passes through the detection area of the optical sensor 60. Therefore, the notifier 79 determines whether the specific state is detected each time a sheet P passes through the detection area of the optical sensor 60.

In response to detection of the specific state, the notifier 79 provides a notification of the specific state. For example, the notifier 79 displays, on the display part 161, a first notification screen that includes the message indicating that the sheet type set in the MFP 100 is different from the sheet type of a sheet P to be printed.

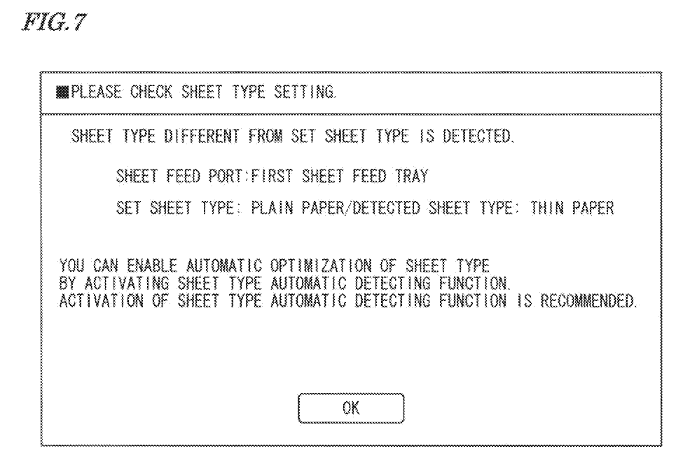

FIG. 7 is a diagram illustrating one example of the first notification screen. With reference to FIG. 7, the first notification screen displays the message “SHEET TYPE DIFFERENT FROM SET SHEET TYPE IS DETECTED.” Therefore, it is possible to notify the user of the specific state using the notification screen. The first notification screen indicates that the tray storing the sheet P on which an image is to be formed is a “FIRST SHEET FEED TRAY.” The first sheet feed tray is a name provided to the sheet feed tray 151. The first notification screen indicates that the set sheet type is a plain paper, and the detected sheet type is a thin paper.

Further, the first notification screen displays the message “YOU CAN ENABLE AUTOMATIC OPTIMIZATION OF SHEET TYPE BY ACTIVATING SHEET TYPE AUTOMATIC DETECTING FUNCTION. ACTIVATION OF SHEET TYPE AUTOMATIC DETECTING FUNCTION IS RECOMMENDED.” With the sheet type automatic detecting function, an image forming condition is determined with the work mode set to the second mode. Therefore, the user can activate the sheet type automatic detecting function by performing an operation of setting the work mode to the second mode.

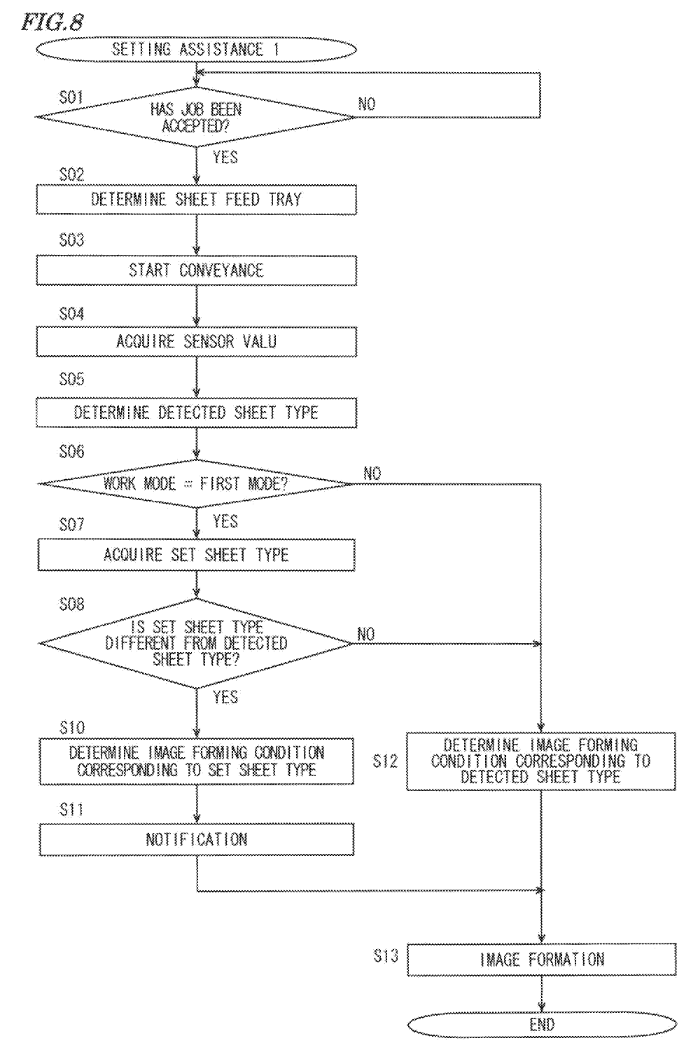

FIG. 8 is a flowchart illustrating one example of a flow of a setting assistance process. The setting assistance process is executed by the CPU 111 included in the MFP 100 when the CPU 111 executes a setting assistance program stored in the ROM 113, the HDD 115 or the CD-ROM 118A. With reference to FIG. 8, the CPU 111 determines whether a job has been accepted (step S01). In a case in which the communication I/F section 112 receives a job from an external computer, the CPU 111 accepts the received job. In a case in which the user operates the operation part 163 to set a job, the CPU 111 accepts the job set via the operation part 163. The job accepted by the CPU 111 is a print job of forming an image on a sheet P or a copy job of forming a duplicated image of a document on the sheet P. The process waits until a job is accepted (NO in the step S01). If a job is accepted (YES in the step S01), the process proceeds to the step S02. The job includes an image forming condition in which a setting value is defined for each of a plurality of items for formation of an image on the sheet P.

In the step S02, a sheet feed tray is determined, and the process proceeds to the step S03. A sheet feed tray defined by an image forming condition included in the job is determined from among the sheet feed trays 151, 152, 153. In the step S03, conveyance of the sheet P stored in the determined sheet feed tray is started, and the process proceeds to the step S04.

In the step S04, a sensor value output by the optical sensor 60 is acquired, and the process proceeds to the step S05. In the step S05, a detected sheet type is determined based on the sensor value, and the process proceeds to the step S06. In the step S06, whether the work mode is set to the first mode is determined. If the work mode is set to the first mode, the process proceeds to the step S07. If not, the process proceeds to the step S12.

In the step S07, a set sheet type is acquired, and the process proceeds to the step S08. The set sheet type is stored in the HDD 115 in correspondence with the sheet feed tray 151 specified in the step S02. In the step S08, whether the set sheet type is different from the detected sheet type is determined. If the set sheet type is different from the detected sheet type, the process proceeds to the step S10. If not, the process proceeds to the step S12. The detected sheet type is determined based on the sensor value in the step S05.

In the step S10, an image forming condition corresponding to the set sheet type is determined, and the process proceeds to the step S11. In the step S11, the notification screen is displayed, and the process proceeds to the step S13. For example, the first notification screen illustrated in FIG. 7 is displayed on the display part 161.

In the step S12, an image forming condition corresponding to the detected sheet type is determined, and the process proceeds to the step S13. In the step S13, an image is formed on the sheet P that is started to be conveyed in the step S03, and the process ends. In a case in which the process proceeds from the step S11, an image is formed on the sheet P in accordance with the image forming condition determined in the step S10. In a case in which the process proceeds from the step S12, an image is formed on the sheet P according to the image forming condition determined in the step S12.

### First Modification Example

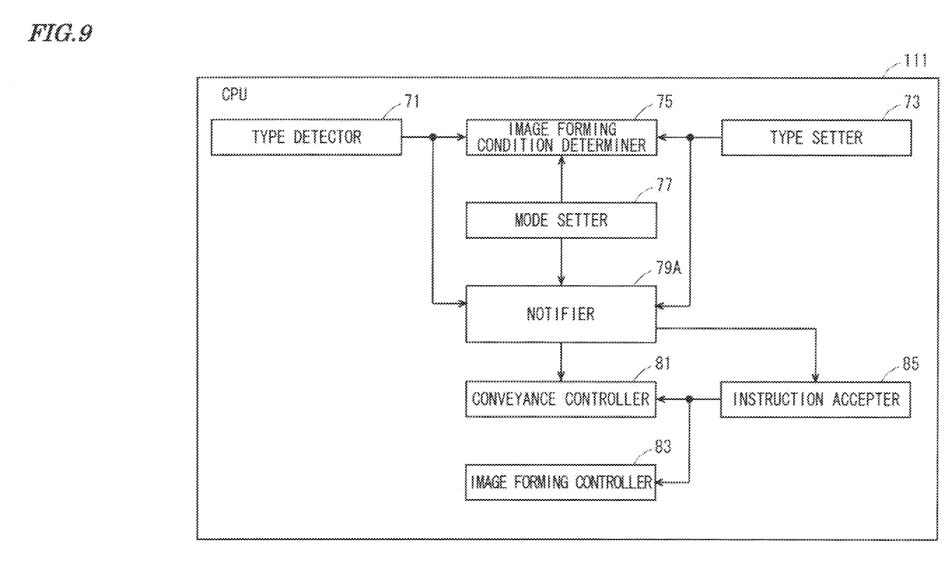

FIG. 9 is a diagram illustrating one example of the functions of a CPU of an MFP in a first modification example. The functions illustrated in FIG. 9 are different from the functions illustrated in FIG. 5 in that the notifier 79 is changed to a notifier 79A, and a conveyance controller 81, an image forming controller 83 and an instruction acceptor 85 are added. The other functions are the same as the functions illustrated in FIG. 5. Therefore, a description thereof will not be repeated here.

The conveyance controller 81 controls a sheet feed section 150. The conveyance controller 81 causes the sheet feed section 150 to convey a sheet P according to an image forming condition determined by an image forming condition determiner 75. The sheet feed section 150 conveys a sheet P stored in a sheet feed tray 151 in a case in which a sheet feed tray 151 is set in the image forming condition. In a case in which a sheet feed tray 152 is set in the image forming condition, a sheet P stored in the sheet feed tray 152 is conveyed. In a case in which a sheet feed tray 153 is set in the image forming condition, a sheet P stored in the sheet feed tray 153 is conveyed. The sheet feed section 150 conveys a sheet P at a conveyance speed defined in an image forming condition.

The image forming controller 83 controls an image forming section 140. The image forming controller 83 causes the image forming section 140 to form an image on a sheet P according to an image forming condition determined by the image forming condition determiner 75. The image forming section 140 controls a roller 54A, a transfer roller 47 and image forming units 51Y, 51M, 51C, 51K to form a toner image on a sheet P at a conveyance speed defined in an image forming condition. Further, the image forming section 140 controls a fixing roller 49 to fix the toner image onto a sheet P at a temperature and a pressing force defined in an image forming condition.

In response to detection of a specific state, the notifier 79A provides a notification of the specific state. For example, the notifier 79A displays a second notification screen on a display part 161. The second notification screen is displayed after the conveyance of a sheet P is stopped. The notifier 79A outputs a stop instruction to the conveyance controller 81 in response to detection of the specific state. In response to receiving the stop instruction, the conveyance controller 81 causes the sheet feed section 150 to stop the conveyance of a sheet P being conveyed. The sheet feed section 150 stops the conveyance of a sheet P by stopping a timing roller 45. The timing roller 45 is arranged upstream of the transfer roller 47. Therefore, the sheet feed section 150 stops the conveyance of a sheet P before the toner image is transferred onto the sheet P.

After displaying the second notification screen, the notifier 79A outputs an acceptance instruction to the instruction acceptor 85. After receiving the acceptance instruction, the instruction acceptor 85 accepts an instruction input by the user to an operation part 163. The instruction input to the operation part 163 by the user is either a continuing instruction for continuing image formation or an interrupting instruction for interrupting image formation. The instruction acceptor 85 outputs the accepted instruction to the conveyance controller 81 and the image forming controller 83.

In response to receiving the continuing instruction or the interrupting instruction from the instruction acceptor 85, the conveyance controller 81 resumes the conveyance of a sheet P that has been stopped. The sheet feed section 150 rotates the timing roller 45 to convey the sheet P toward the transfer roller 47.

In response to receiving the continuing instruction, the image forming controller 83 controls the image forming section 140 to form an image on the sheet P. Specifically, the image forming controller 83 controls the roller 54A, the transfer roller 47 and the image forming units 51Y, 51M, 51C, 51K to form a toner image on the sheet P at a conveyance speed defined in an image formation condition. Further, the image forming controller 83 controls the fixing roller 49 to fix the toner image on the sheet P with a temperature and a pressing force defined in image forming conditions.

In response to receiving the interrupting instruction, the image forming controller 83 controls the image forming section 140 not to form an image on a sheet P. Specifically, although controlling the roller 54A and the transfer roller 47 to convey a sheet P, the image forming controller 83 controls the image forming units 51Y, 51M, 51C, 51K not to form a toner image on an intermediate transfer belt 57. Further, the image forming controller 83 controls the fixing roller 49 to convey the sheet P. Any temperature and any pressure of the fixing roller 49 can be set. Thus, the sheet P on which no image is formed is discharged to a sheet ejection tray of a post-processing device 155.

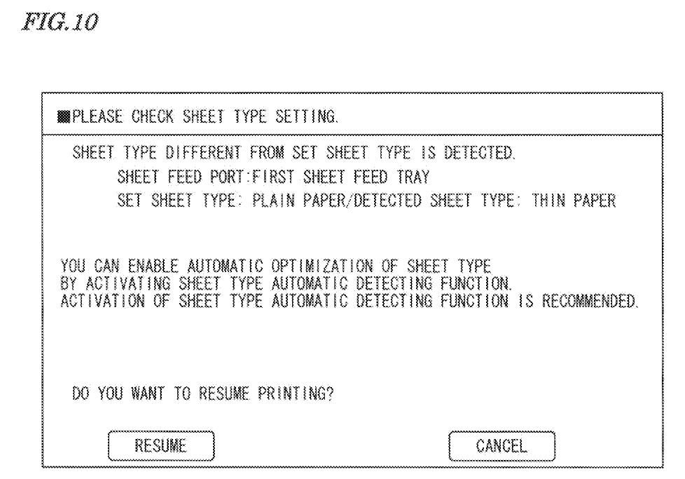

FIG. 10 is a diagram illustrating one example of the second notification screen. With reference to FIG. 10, the second notification screen is different from the first notification screen illustrated in FIG. 7 in that the message “DO YOU WANT TO RESUME PRINTING?,” the button in which the characters “RESUME" are displayed, and the button in which the characters “CANCEL" are displayed are added. In a case in which the user designates the button in which the characters “RESUME” are displayed, the instruction acceptor 85 accepts the continuing instruction. In a case in which the user designates the button in which the characters “CANCEL" are displayed, the instruction acceptor 85 accepts the interrupting instruction.

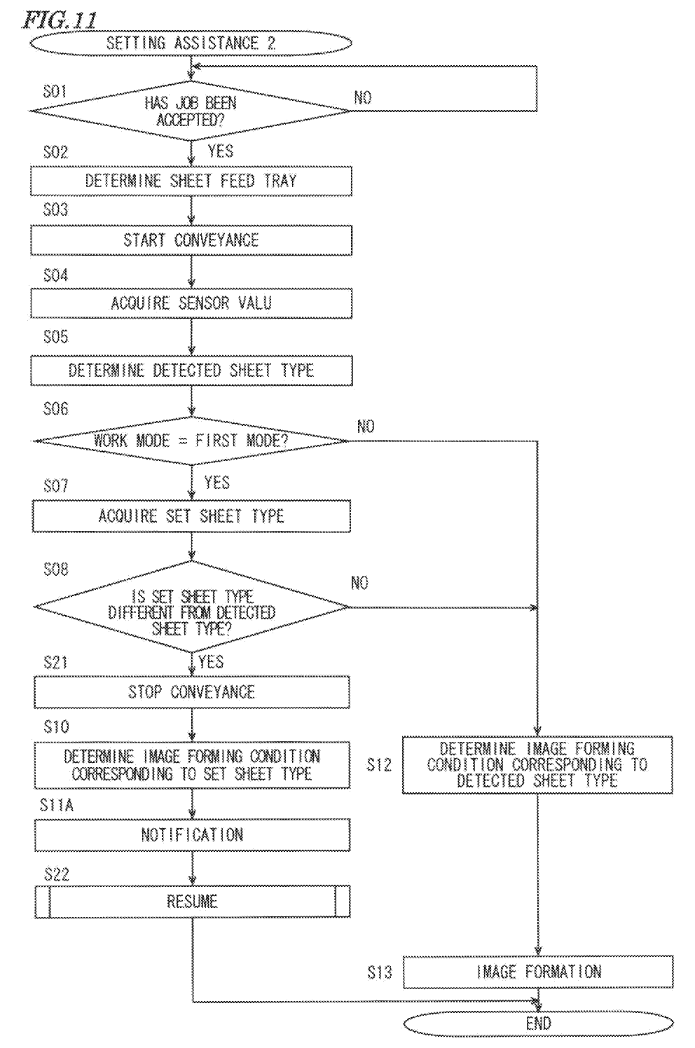

FIG. 11 is a flowchart illustrating one example of a flow of a setting assistance process in the first modification example. The setting assistance process in the first modification example is different from the setting assistance process illustrated in FIG. 8 in that the step 11 is changed to the step S11A. Further, the step S21 is added between the step S08 and the step S09, and the step S22 is added after the step S11. The other processes are the same as the processes illustrated in FIG. 8. Therefore, a description thereof will not be repeated here.

In the step S11A, the second notification screen illustrated in FIG. 10 is displayed on the display part 161. In the step S21, the conveyance of a sheet P is stopped, and the process proceeds to the step S08. In a case in which a work mode is not a first mode, and a set sheet type is different from a detected sheet type, a CPU 111 stops the timing roller 45 to stop the sheet P in a main conveyance route 41 before an image is formed on the sheet P. In the step S22, a resuming process is executed, and the process ends.

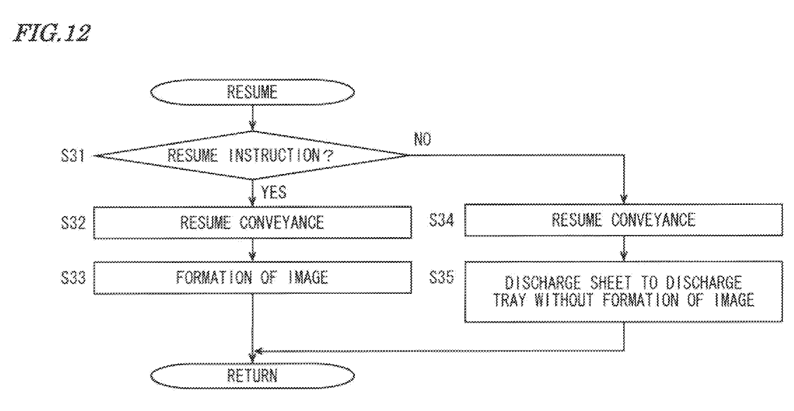

FIG. 12 is a flowchart illustrating one example of a flow of the resuming process. The resuming process is executed in the step S22 of the setting assistance process in the first modification example. Before the resuming process is executed, the sheet P to be processed is stopped in the main conveyance route 41.

In the step S31, whether a resume instruction is accepted is determined. In a case in which the button in which the characters “RESUME" are displayed is designated in the second notification screen displayed on display part 161 in the step S11, the resume instruction is accepted. In a case in which the button in which the characters “CANCEL" are displayed is designated in the second notification screen displayed on display part 161 in the step S11, an interrupting instruction is accepted. If the resume instruction has been accepted, the process proceeds to the step S32. If the interrupting instruction has been accepted, the process proceeds to the step S34. In the step S32, the conveyance of the sheet P is resumed, and the process proceeds to the step S33. In the step S33, an image is formed on the sheet P, and the process returns to the setting assistance process.

In the step S34, the conveyance of the sheet P is resumed, and the process proceeds to the step S35. In the step S35, the sheet P is discharged to the sheet ejection tray without formation of an image on the sheet P, and the process returns to the setting assistance process. The CPU 111 causes the sheet feed section 150 to convey the sheet P without formation of an image on the sheet P and discharge the sheet P to the sheet ejection tray.

### Modification Example of Second Notification Screen

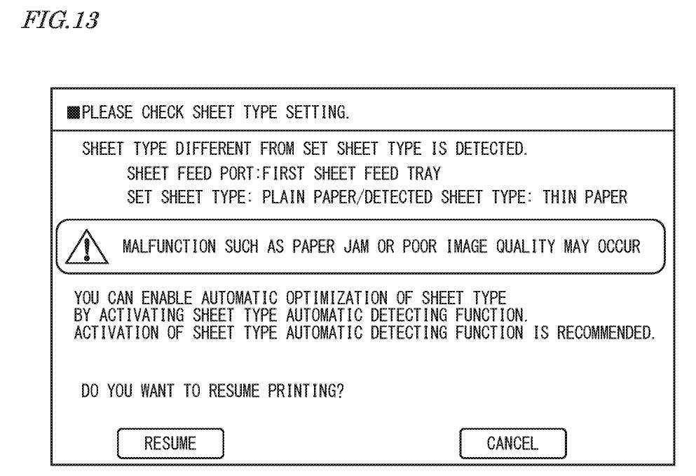

The second notification screen may include a message notifying that a malfunction may occur. FIG. 13 is a diagram illustrating a modification example of the second notification screen. With reference to FIG. 13, the second notification screen in the modification example is different from the second notification screen illustrated in FIG. 10 in that the message “MALFUNCTION SUCH AS PAPER JAM OR POOR IMAGE QUALITY MAY OCCUR.” is displayed.

### Second Modification Example

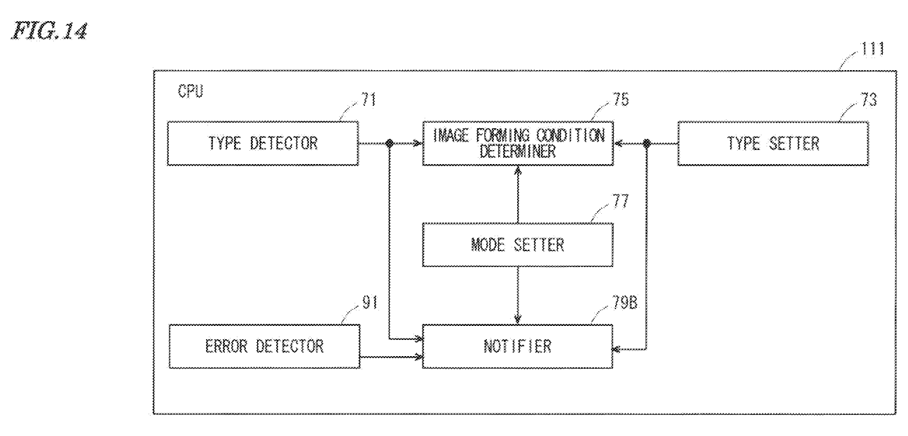

FIG. 14 is a diagram illustrating one example of the functions of a CPU included in an MFP in a second modification example. The functions illustrated in FIG. 14 are different from the functions illustrated in FIG. 5 in that an error detector 91 is added and that the notifier 79 is changed to a notifier 79B. The other functions are the same as the functions illustrated in FIG. 5. Therefore, a description thereof will not be repeated here.

The error detector 91 detects a conveyance error. The conveyance error is an event in which a sheet P is not conveyed. In a sheet feed section 150, sheet detection sensors for detecting the presence or absence of a sheet P are arranged at a plurality of positions in each of a main conveyance route 41 and an inverting route 43. The sheet detection sensor detects the presence or absence of a sheet P. The sheet detection sensor may be a photoelectric sensor, or may be a combination of a lever the position of which is changed depending on the presence or absence of a sheet and a contact switch.

The sheet feed section 150 conveys a sheet P stored in any one of sheet feed trays 151, 152, 153 along the main conveyance route 41 or the inverting route 43. A conveyance speed at which the sheet feed section 150 conveys the sheet P is defined by an image forming condition. Therefore, the error detector 91 obtains a position of the sheet P in the main conveyance route 41 or the inverting route 43 at a certain point in time by calculation. The error detector 91 checks whether a position of the sheet P obtained by calculation matches a position of the sheet P detected by the sheet detection sensor. The error detector 91 detects an error in a case in which the position of the sheet P obtained by calculation is different from the position of the sheet P detected by the sheet detection sensor. Further, the error detector 91 may detect an error in which the sheet P is jammed in a case in which the sheet detection sensor detects the sheet P continuously for a predetermined period of time.

In response to detection of an error by the error detector 91 in the case of a specific state, the notifier 79B provides a notification of the specific state. For example, the notifier 79B displays a third notification screen on a display part 161. The third notification screen is displayed after an error is detected by the error detector 91. In the MFP 100 of the second modification example, it is possible to allow formation of an image according to an image forming condition different from an image forming condition suitable for a sheet P, and the number of times a notification is provided is reduced. This improves convenience of a user operation. Further, in a case in which an error is detected, it is possible to notify that the error is caused by the setting of sheet type.

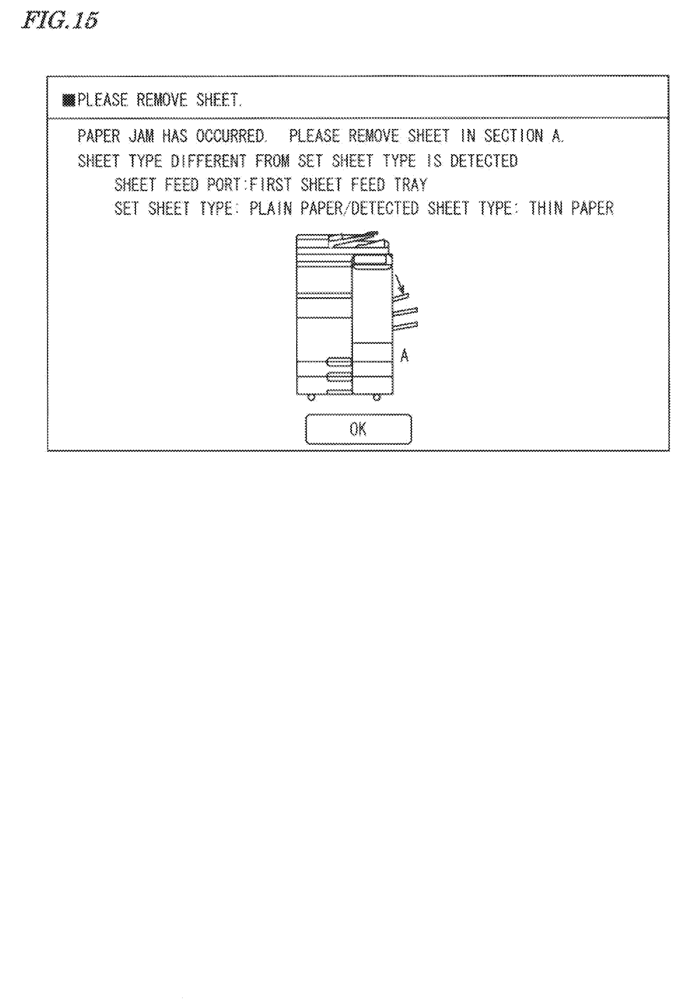

FIG. 15 is a diagram illustrating one example of the third notification screen. With reference to FIG. 15, the third notification screen notifies the user of an occurrence of a paper jam. In the third notification screen, the message “SHEET TYPE DIFFERENT FROM SET SHEET TYPE IS DETECTED.” is displayed. Therefore, it is possible to notify the user of the specific state using the notification screen. The third notification screen represents that a tray storing a sheet P on which an image is to be formed is a “FIRST SHEET FEED TRAY.” The first sheet feed tray is a name provided to the sheet feed tray 151. The first notification screen indicates that the set sheet type is a plain paper and the detected sheet type is a thin paper.

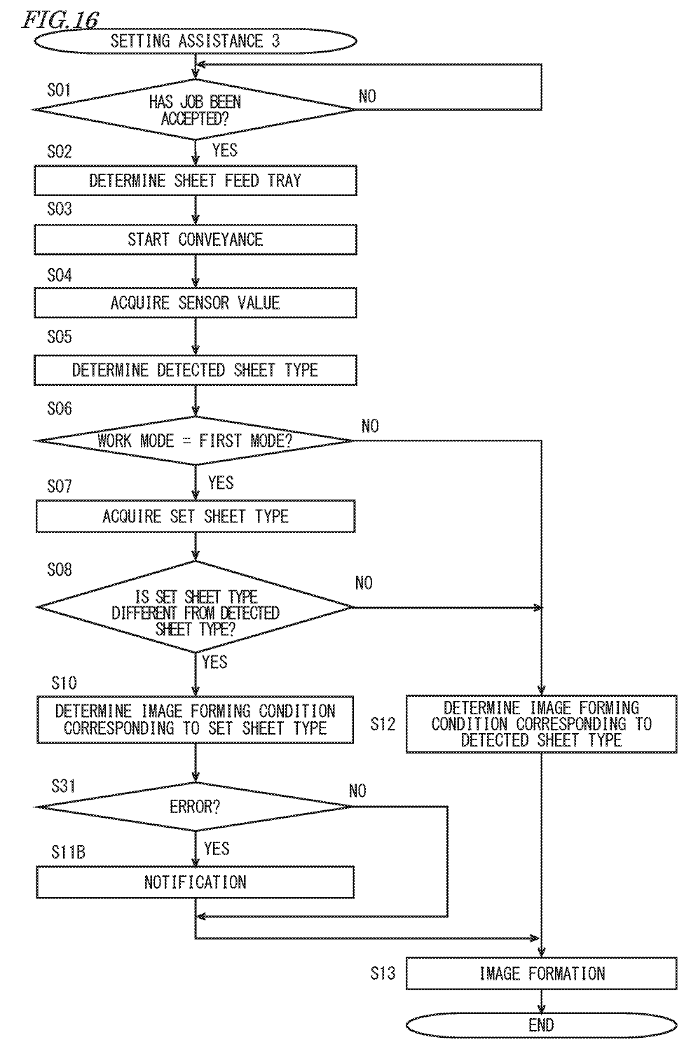

FIG. 16 is a flowchart illustrating one example of a flow of a setting assistance process in the second modification example. The setting assistance process in the second modification example is different from the setting assistance process illustrated in FIG. 8 in that the step S11 is changed to the step S11B and that the step S31 is added between the step S10 and step S11B. The other processes are the same as the processes illustrated in FIG. 8. Therefore, a description thereof will not be repeated here.

In the step S31, whether an error related to conveyance of a sheet P has been detected is determined. If an error is detected, the process proceeds to the step S11A. If not, the process proceeds to the step S13. In the step S11A, the third notification screen is displayed on the display part 161. In a case in which a work mode is not a first mode and a set sheet type is different from a detected sheet type, the CPU 111 does not display the third notification screen until an error is detected. Therefore, it is possible to allow formation of an image according to an image forming condition different from an image forming condition suitable for the sheet P, and the number of times a notification is provided is reduced. As a result, it improves convenience of a user operation.

### Third Modification Example

The MFP 100 in the second modified example, similarly to the MFP 100 in the first modified example, may stop conveyance of a sheet P before an image is formed. In this case, a CPU 111 displays a fourth notification screen on a display part 161.

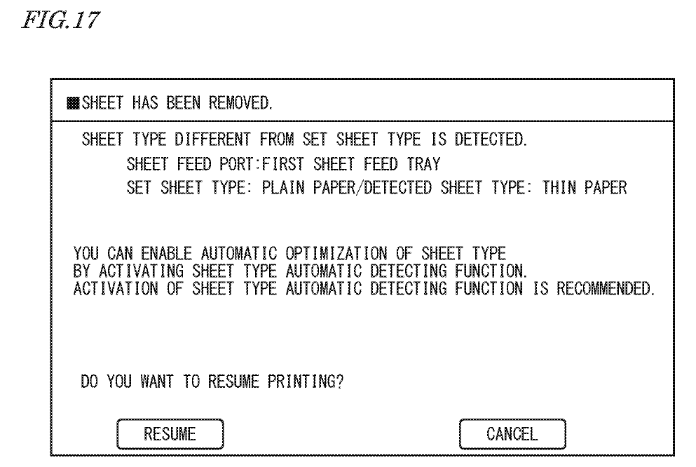

FIG. 17 is a diagram illustrating one example of the fourth notification screen. With reference to FIG. 17, the fourth notification screen notifies the user that a sheet has been removed. The fourth notification screen displays the message “SHEET TYPE DIFFERENT FROM SET SHEET TYPE IS DETECTED.” Therefore, it is possible to notify the user of a specific state by using the fourth notification screen. The fourth notification screen indicates that a tray storing a sheet P on which an image is to be formed is a “FIRST SHEET FEED TRAY." The first sheet feed tray is a name provided to a sheet feed tray 151.

Further, the fourth notification screen differs in that the message “RESUME PRINTING?," the button in which the characters “RESUME" are displayed, and the button in which the characters “CANCEL" are added. In a case in which the user designates the button in which the characters “RESUME” are displayed, the instruction acceptor 85 accepts a continuing instruction. In a case in which the user designates the button in which the characters “CANCEL" are displayed, the instruction acceptor 85 accepts an interrupting instruction.

### Fourth Modification Example

Although being defined as the state in which a set sheet type is different from a detected sheet type, the specific state may be defined as the state in which the difference between a detected sheet type and a set sheet type is equal to or larger than a predetermined threshold value. An MFP 100 in the fourth modification example provides a notification in a case in which a detected sheet type is different from a set sheet type, and the difference between the detected sheet type and the set sheet type is equal to or larger than a predetermined value.

With reference to the sheet type table illustrated in FIG. 6, sheet types are indicated by basis weights, by way of example. For example, the lowest value of the range of basis weight corresponding to a sheet type is the basis weight of the sheet type. In this case, the difference between the basis weight corresponding to a detected sheet type and the basis weight corresponding to a set sheet type is indicated as the difference between the detected sheet type and the set sheet type.

The basis weight corresponding to the sheet type “THIN PAPER” is 50, the basis weight corresponding to the sheet type “PLAIN PAPER” is 60, and the basis weight corresponding to the sheet type “PLAIN PAPER +” is 90. The difference between the sheet type “THIN PAPER" and the sheet type “PLAIN PAPER" is 10. The difference between the sheet type “THIN PAPER” and the sheet type “PLAIN PAPER +” is 40. In this case, in a case in which the threshold value is set to 20, the specific state is not detected in a case in which a set sheet type is a thin paper and a detected sheet type is a plain paper. However, the specific state is detected in a case in which a set sheet type is a thin paper and a detected sheet type is a plain paper +.

### Other Modification Examples

(1) While the CPU 111 detects a sheet type based on an output of the optical sensor 60 in the present embodiment, the present invention is not limited to this. The CPU 111 may detect a load of a driving source of the conveyance roller that conveys a sheet P to detect a sheet type based on the load. The larger a basis weight, the larger a load. For example, the CPU 111 detects a load of a motor that drives the timing roller 45.

(2) Although the optical sensor 60 is described as a through-beam sensor, it may be a reflective optical sensor. The reflective optical sensor includes a light emitter and a light receiver, and is arranged between the lower end portion 30 of the main conveyance route 41 and the timing roller 45. In the reflective optical sensor, the light emitter and the light receiver are arranged on one side of the main conveyance route 41. The reflective optical sensor outputs a value indicating the reflectance of light. The reflectance indicates the ratio of an amount of light received by the light receiver to an amount of light output by the light emitter. The reflectance of light varies depending on the state of the surface of a sheet P, and there is a predetermined relationship between the reflectance of light and a color of the surface of the sheet P. The whiter the surface of a sheet P, the larger the reflectance of light. Therefore, by obtaining the relationship between the whiteness of a sheet P and the reflectance of light by an experiment or the like, the whiteness of the sheet P is determined based on the reflectance of light. Further, a sheet type may be determined by a color or smoothness. Further, a sheet type may be determined by a combination of an output of a through-beam sensor and an output of a reflective optical sensor.

(3) An ultrasonic sensor may be used instead of an optical sensor or in addition to an optical sensor. An ultrasonic sensor includes an ultrasonic transmitter and an ultrasonic receiver, and is transmissive. The ultrasonic sensor is arranged between the lower end portion 30 of the main conveyance route 41 and the timing roller 45. The ultrasonic transmitter and the ultrasonic receiver are arranged so as to be opposite to each other with the main conveyance route 41 therebetween. The ultrasonic transmitter includes a piezoelectric element and a drive circuit for the piezoelectric element, and transmits an ultrasonic wave. The ultrasonic wave receiver includes a piezoelectric element, and a detection circuit that detects an electromotive force generated in the piezoelectric element, and detects an electromotive force generated in the piezoelectric element using an ultrasonic wave transmitted from the ultrasonic transmitter. An area in the main conveyance route 41 between the ultrasonic transmitter and the ultrasonic receiver is a detection area.

The ultrasonic sensor outputs a value indicating the attenuation amount of an ultrasonic wave. Here, a value indicating the attenuation amount of an ultrasonic wave is an attenuation rate. The attenuation rate of an ultrasonic wave of a sheet P is significantly different from that of a double-layer paper. This is because two sheets P are superimposed in a double-layer paper. When two sheets P are superimposed on each other, a gap is present between the two sheets P. Therefore, the rate of attenuation of an ultrasonic wave caused by a double-layer paper is significantly smaller than the rate of attenuation of an ultrasonic wave caused by one sheet P. Therefore, it is possible to detect the presence or absence of superimposition of two sheets P based on the attenuation rate of an ultrasonic wave. Further, an attenuation rate indicates the ratio of the sound volume of an ultrasonic wave transmitted through an object to be conveyed with respect to the sound volume of a transmitted ultrasonic wave. The attenuation rate of an ultrasonic wave varies depending on the basis weight of a sheet P. There is a predetermined relationship between the attenuation rate of an ultrasonic wave and the basis weight of the sheet P. The larger the basis weight of a sheet P, the smaller the attenuation rate of an ultrasonic wave. Therefore, the basis weight of a sheet P may be determined based on the attenuation rate of an ultrasonic wave by acquisition of the relationship between the basis weight of the sheet P and the attenuation rate of the ultrasonic wave.

### Overview of Embodiment

(Item 1) An image forming apparatus includes a hardware processor, wherein the hardware processor sets a type of a recording medium, detects the type of a recording medium on which an image is to be formed, determines, in a first mode, an image formation condition based on the set type, and determines, in a second mode, the image forming condition based on the detected type, sets a work mode to either the first mode or the second mode, and in a case of, with the first mode being set, a specific state where the set type is different from the detected type, prompts switching of the work mode.

According to this aspect, the work mode is set to either the first mode or the second mode, an image forming condition is determined in the first mode based on a type set by the type setter, and an image forming condition is determined in the second mode based on a type detected by the type detector. In the case of, with the first mode being set, the specific state where a type set by the type setter and a type detected by the type detector are different from each other, it is notified that the work mode is to be switched. Therefore, in a case in which an image forming condition for formation of an image on a recording medium is different from an image forming condition corresponding to the type of the recording medium, the user is prompted to switch the work mode. In a case in which an image is formed according to an image forming condition different from an image forming condition corresponding to the type of a recording medium, a malfunction is likely to occur. A malfunction includes degradation of quality of an image formed on a recording medium or an occurrence of an event in which a recording medium is not normally conveyed, for example. Therefore, because the user is prompted to perform an operation, user operability is improved. As a result, it is possible to provide the image forming apparatus that assists the user such that an image is formed according to an appropriate image forming condition with respect to the type of a recording medium.

(Item 2) The image forming apparatus according to item 1, wherein the hardware processor detects an error in which a recording medium is not conveyed, and provides a notification in response to detection of an error in a case of the specific state.

According to this aspect, a notification is provided in response to detection of an error in the case of the specific state. Because a notification is provided after a malfunction occurs for the first time, it is possible to allow formation of an image according to an image forming condition different from an image forming condition suitable for a recording medium, and the number of times a notification is provided is reduced. Thus, it improves operability. Further, in a case in which an error is detected, it is possible to notify that the error is caused by the setting for the sheet type.

(Item 3) The image forming apparatus according to item 1, wherein the hardware processor provides a notification in response to detection of the specific state.

According to this aspect, because a notification is provided in response to detection of the specific state, a notification can be provided before a malfunction occurs.

(Item 4) The image forming apparatus according to item 3, wherein the hardware processor provides a notification indicating that a malfunction is predicted.

According to this aspect, because it is notified that a malfunction is predicted, it is possible to prompt the user to perform an operation of changing the work mode to the second mode.

(Item 5) The image forming apparatus according to item 3 or 4, wherein in a case in which a difference between the set type and the detected type is equal to or larger than a predetermined value, the hardware processor provides a notification.

According to this aspect, a notification is provided in a case in which the difference between a type set by the type setter and a type detected by the type detector is equal to or larger than the predetermined threshold value. Therefore, the larger the difference in type, the larger the difference in image forming condition. The larger the difference in type, the larger the probability of an occurrence of a malfunction. Therefore, because a notification is provided in a case in which the probability of occurrence of a malfunction is high, the number of times a notification is provided is reduced. Therefore, it is possible to improve user convenience by reducing the number of notifications.

(Item 6) The image forming apparatus according to any one of items 1 to 5, wherein the hardware processor notifies that the image formation condition does not correspond to the type of a recording medium on which an image is to be formed.

According to this aspect, it is notified that an image forming condition does not correspond to the type of a recording medium on which an image is to be formed. Therefore, it is possible to notify the user that the setting of type of a recording medium on which an image is formed is incorrect.

(Item 7) The image forming apparatus according to any one of items 1 to 6, further includes a conveyance section that conveys a recording medium through a conveyance route, and a sensor provided in the conveyance route, wherein the hardware processor detects the type based on an output of the sensor.

According to this aspect, because a type is detected based on an output of the sensor provided in the conveyance route, it is possible to detect the type of a recording medium being conveyed before an image is formed.

(Item 8) The image forming apparatus according to any one of items 1 to 7, further includes a conveyance section that conveys a recording medium through a conveyance route, wherein the hardware processor, in a case of the specific state, controls the conveyance section to stop conveyance of a recording medium being conveyed through the conveyance route.

According to this aspect, in the case of the specific state, the conveyance of a recording medium being conveyed through the conveyance route is stopped. Therefore, because the conveyance of the recording medium is stopped before an image is formed, it is possible to prevent an image from being formed on the recording medium according to an image forming condition not corresponding to the recording medium.

(Item 9) The image forming apparatus according to item 8, further includes an image forming section that forms an image on a recording medium conveyed by the conveyance section, wherein the hardware processor accepts an instruction input by a user after the specific state is detected, and controls the conveyance section to resume conveyance of a recording medium in response to acceptance of the instruction, and controls the image forming section to form an image on a recording medium in a case in which the instruction indicates that an image is to be formed, and controls the image forming section not to form an image on a recording medium in a case in which the instruction indicates that an image is not to be formed.

According to this aspect, because an image is formed on a recording medium in a case in which a resume instruction indicates that an image is to be formed, it is possible to form the image on the recording medium according to an image forming condition that does not correspond to the type of the recording medium. Further, in a case in which the resume instruction indicates that an image is not to be formed, an image is not formed on a recording medium. Therefore, it is possible to prevent the image from being formed on the recording medium according to an image forming condition not corresponding to the type of the recording medium. Because whether an image is to be formed is determined by a user’ s instruction to resume, user convenience can be improved.

(Item 10) The image forming apparatus according to item 8 or 9, wherein the sensor includes a light source, and a light receiver that receives transmitted light and/or reflected light of light with which a recording medium is irradiated by the light source, and the hardware processor detects the type of a recording medium based on transmittance of the transmitted light or reflectance of the reflected light.

(Item 11) The image forming apparatus according to item 7, wherein the conveyance section includes a conveyance roller that conveys a recording medium, and a driving source of the conveyance roller, the sensor detects a load of the driving source, and the hardware processor detects the type of a recording medium based on a load of the driving source detected by the sensor.

(Item 12) A setting assistance method includes a type setting step of setting a type of a recording medium, a detecting step of detecting the type of a recording medium on which an image is to be formed, an image forming condition determining step of determining an image forming condition based on the type set in the type setting step in a first mode, and determining an image forming condition based on the type detected in the detecting step in a second mode, a mode setting step of setting a work mode to either the first mode or the second mode, and a notifying step of prompting switching of the work mode in a case of, with the first mode being set, a specific state where the type set in the type setting step is different from the type detected in the detecting step.

According to this aspect, it is possible to provide the setting assistance method of assisting the user such that an image is formed according to an image forming condition suitable for the type of a recording medium.

(Item 13) A computer-readable recording medium is encoded with a setting assistance program that causes a computer controlling an image forming apparatus to execute a type setting step of setting a type of a recording medium, a detecting step of detecting the type of a recording medium on which an image is to be formed, an image forming condition determining step of determining an image forming condition based on the type set in the type setting step in a first mode, and determining an image forming condition based on the type detected in the detecting step in a second mode, a mode setting step of setting a work mode to either the first mode or the second mode, and a notifying step of prompting switching of the work mode in a case of, with the first mode being set, a specific state where the type set in the type setting step is different from the type detected in the detecting step.

According to this aspect, it is possible to provide the setting assistance program that assists the user such that an image is formed according to an image forming condition suitable for the type of a recording medium.

It should be understood that the embodiments disclosed herein are illustrative and non-restrictive in every respect. The scope of the present invention is defined not by the above description but by the appended claims, and is intended to include any modifications within the scope and meaning equivalent to the appended claims.

Although embodiments of the present invention have been described and illustrated in detail, the disclosed embodiments are made for purpose of illustration and example only and not limitation. The scope of the present invention should be interpreted by terms of the appended claims.

What is claimed is:

1. An image forming apparatus comprising a hardware processor, wherein
the hardware processor
sets a type of a recording medium,
detects the type of a recording medium on which an image is to be formed,
determines, in a first mode, an image formation condition based on the set type, and determines, in a second mode, the image forming condition based on the detected type,
sets a work mode to either the first mode or the second mode, and
in a case of, with the first mode being set, a specific state where the set type is different from the detected type, prompts switching of the work mode.

2. The image forming apparatus according to claim 1, wherein
the hardware processor
detects an error in which a recording medium is not conveyed, and
provides a notification in response to detection of an error in a case of the specific state.

3. The image forming apparatus according to claim 1, wherein
the hardware processor provides a notification in response to detection of the specific state.

4. The image forming apparatus according to claim 3, wherein
the hardware processor provides a notification indicating that a malfunction is predicted.

5. The image forming apparatus according to claim 3, wherein
in a case in which a difference between the set type and the detected type is equal to or larger than a predetermined value, the hardware processor provides a notification.

6. The image forming apparatus according to claim 1, wherein
the hardware processor notifies that the image formation condition does not correspond to the type of a recording medium on which an image is to be formed.

7. The image forming apparatus according to claim 1, further comprising:
a conveyance section that conveys a recording medium through a conveyance route; and
a sensor provided in the conveyance route, wherein
the hardware processor detects the type based on an output of the sensor.

8. The image forming apparatus according to claim 1, further comprising a conveyance section that conveys a recording medium through a conveyance route, wherein
the hardware processor, in a case of the specific state, controls the conveyance section to stop conveyance of a recording medium being conveyed through the conveyance route.

9. The image forming apparatus according to claim 8, further comprising an image forming section that forms an image on a recording medium conveyed by the conveyance section, wherein
the hardware processor
accepts an instruction input by a user after the specific state is detected, and
controls the conveyance section to resume conveyance of a recording medium in response to acceptance of the instruction, and
controls the image forming section to form an image on a recording medium in a case in which the instruction indicates that an image is to be formed, and controls the image forming section not to form an image on a recording medium in a case in which the instruction indicates that an image is not to be formed.

10. The image forming apparatus according to claim 7, wherein
the sensor includes
a light source, and
a light receiver that receives transmitted light and/or reflected light of light with which a recording medium is irradiated by the light source, and
the hardware processor detects the type of a recording medium based on transmittance of the transmitted light or reflectance of the reflected light.

11. The image forming apparatus according to claim 7, wherein
the conveyance section includes
a conveyance roller that conveys a recording medium, and
a driving source of the conveyance roller,
the sensor detects a load of the driving source, and
the hardware processor detects the type of a recording medium based on a load of the driving source detected by the sensor.

12. A setting assistance method including:
a type setting step of setting a type of a recording medium;
a detecting step of detecting the type of a recording medium on which an image is to be formed;
an image forming condition determining step of determining an image forming condition based on the type set in the type setting step in a first mode, and determining an image forming condition based on the type detected in the detecting step in a second mode;
a mode setting step of setting a work mode to either the first mode or the second mode; and
a notifying step of prompting switching of the work mode in a case of, with the first mode being set, a specific state where the type set in the type setting step is different from the type detected in the detecting step.

13. The setting assistance method according to claim 12, that further causes the image forming apparatus to:
detect an error in which a recording medium is not conveyed; and
provide a notification in response to detection of an error in a case of the specific state.

14. The setting assistance method according to claim 12, that further causes the image forming apparatus to provide a notification in response to detection of the specific state.

15. The setting assistance method according to claim 14, including providing a notification indicating that a malfunction is predicted.

16. The setting assistance method according to claim 14, including providing a notification in a case in which a difference between the set type and the detected type is equal to or larger than a predetermined threshold value.

17. The setting assistance method according to claim 12, including providing a notification indicating that the image forming condition does not correspond to the type of a recording medium on which an image is to be formed.

18. The setting assistance method according to claim 12, wherein
the image forming apparatus further includes
a conveyance section that conveys a recording medium through a conveyance route, and
a sensor provided in the conveyance route, and
the setting assistance method includes detecting the type based on an output of the sensor.

19. The setting assistance method according to claim 12, wherein
the image forming apparatus further includes a conveyance section that conveys a recording medium through a conveyance route, and
the setting assistance method further includes, in a case of the specific state, controlling the conveyance section to stop conveyance of a recording medium being conveyed through the conveyance route.

20. A computer-readable recording medium encoded with a setting assistance program that causes a computer controlling an image forming apparatus to execute:
a type setting step of setting a type of a recording medium;
a detecting step of detecting the type of a recording medium on which an image is to be formed;
an image forming condition determining step of determining an image forming condition based on the type set in the type setting step in a first mode, and determining an image forming condition based on the type detected in the detecting step in a second mode;
a mode setting step of setting a work mode to either the first mode or the second mode; and
a notifying step of prompting switching of the work mode in a case of, with the first mode being set, a specific state where the type set in the type setting step is different from the type detected in the detecting step.
